(19) United States
(12) Patent Application Publication
(10) Pub. No.: US 2002/0097834 A1
(43) Pub. Date: Jul. 25, 2002

(54) X-ray analysis apparatus

(76) Inventor: Masao Satoh, Chiba-shi (JP)

Correspondence Address: ADAMS & WILKS, 31st Floor, 50 Broadway, New York, NY, 10004, US

(21) Appl. No.: 09/977,980

(22) Filed: Oct. 15, 2001

(30) Foreign Application Priority Data
Oct. 20, 2000 (JP) 2000-321319

(51) Int. Cl. G01T 1/36; G01N 23/223

(52) U.S. Cl. 378/46

(57) ABSTRACT

To achieve elemental analysis and structural analysis with an X-ray apparatus employing X-rays characterized by being non-destructive and non-contacting.

There is provided a common X-ray emitting source 1, a collimator 3 focusing first order X-rays, an energy distributed X-ray detector 9 for X-ray fluorescence analysis taken as an elementary analysis means, a CCD line sensor 6 for X-ray diffraction taken as structural analysis means, a sample observation optical system for confirming the measuring position of a microscopic portion, and a control calculator 11 for analyzing respective results.

### BACKGROUND OF THE INVENTION

The present invention relates to an X-ray analysis apparatus combining the functions of an X-ray fluorescence analyzer and an X-ray diffractometer.

Conventionally, elementary and quantative analysis are performed using an X-ray fluorescence analysis apparatus, and are executed separately from structural analysis which uses an x-ray diffractometer. In X-ray fluorescence analysis, it is necessary to predetermine a sample structural element in order to obtain accurate values by applying a fundamental parameter (FP) method, which is a determination method employing theoretical calculations. In the case of quantative analysis of as yet unknown samples, sample structure is estimated from the results of qualitative analysis using a fluorescent X-ray method, or structural analysis is performed in advance using an analysis method such as X-ray diffraction and an accurate sample structure from the result is then input to be analyzed quantitatively using the X-ray fluorescence analysis method. A system, in which a semiconductor detector for EDX is added to an X-ray diffractometer with a goniometer installed in an angle scanning method for detecting X-ray intensity at each angle by moving to and stopping an X-ray detector at a designated angle, is also utilized for the same purpose.

Conventionally, an X-ray fluorescence analyzer is used for elementary analysis. Although composition of each element can be obtained, it is impossible to analyze whether such a composition is oxide, nitride or halide. In the case of such a purpose, it is necessary to measure and identify a diffraction patterns using an X-ray diffractometer.

There is a problem with related X-ray diffractometers with regards to implementing an X-ray fluorescence analyzer and an X-ray diffractometer in a single apparatus, in that in an angle scanning method where an X-ray detector is moved to and stopped at a desired angle by a goniometer and X-ray intensity at each angle is detected, more time is required for measurement, more installation space is necessary for the detection system, and a long path for a first order X-ray irradiation system for X-ray fluorescence analysis and a detection system is also required for installing an X-ray fluorescence analysis system and X-ray diffraction detection system which causes the efficiency of detection to be poor. A high output X-ray emitting source of more than a few kW therefore needs to be provided, which makes the size of the apparatus cumbersome.

When two types of apparatus, an X-ray fluorescence analyzer and an X-ray diffractometer, are installed separately, a large installation space and double the measuring time are required. There is also a problem that submission of installation for two types of apparatus is required.

### SUMMARY OF THE INVENTION

By providing an X-ray high voltage source, an X-ray tube which is an X-ray emitting source, a collimator, a sample observation optical system, a sample stage and an operational control calculator used in common, and an energy distributed X-ray detector for performing elementary and quantative analysis by detecting X-ray fluorescence, for example, an Si (Li) semiconductor detector and small-type CCD line sensor for structural analysis, it is not necessary to have such a large installation space and to maintain an X-ray irradiation system distance between an X-ray tube and a sample, which makes it possible to obtain an X-ray fluorescence spectrum and an X-ray diffraction pattern at the same time with a one-time irradiation with X-rays of a low power X-ray output which is lower than 100W.

### BRIEF DESCRIPTION OF THE DRAWINGS

FIG. 1 is a perspective view of a CCD line sensor for measuring X-ray diffraction.

FIG. 2 is an explanatory drawing of one of embodiments of the present invention.

### DETAILED DESCRIPTION OF THE PREFERRED EMBODIMENT

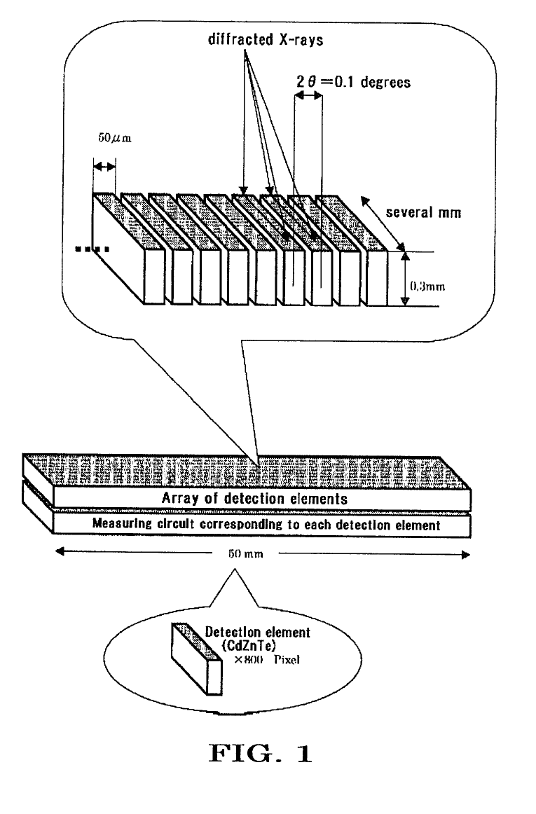

An image of a CCD line sensor for measuring X-ray diffraction is shown in FIG. 1. The width of detection elements lined up in a line direction corresponds to the angle of resolution of a diffraction line generated from a sample so that, for example, when a detection element is fitted a distance of 50 mm from a sample at an angle of 45 degrees, if eight hundred elements of 50 um are lined up 50 mm from a sample, the angle (2θ) of resolution of the diffraction lines becomes about 0.10 degrees. With this arrangement, angle (2θ information of a range from 10 to 80 degrees can be obtained as a diffraction spectrum and this data is sufficient for structural analysis of a powder crystal.

As a detection element composition for the CCD line sensor 6 for measuring X-ray diffraction, Si, amorphous Si and amorphous Se can be used in low energy measurement using a Cu tube or a Cr tube. However, a wide range of X-ray energy is required to be measured in order to perform quantative analysis of as yet unknown samples with X-ray fluorescence analysis, so that an Rh tube and Mo tube are generally used. In this case, high-energy characteristic X-ray diffraction of Rh and Mo is required to be detected. However, Si of a low atomic number allows high-energy X-rays to pass and the efficiency of detection is poor, so that CdTe and CdZnTe of material of a high atomic number, are employed.

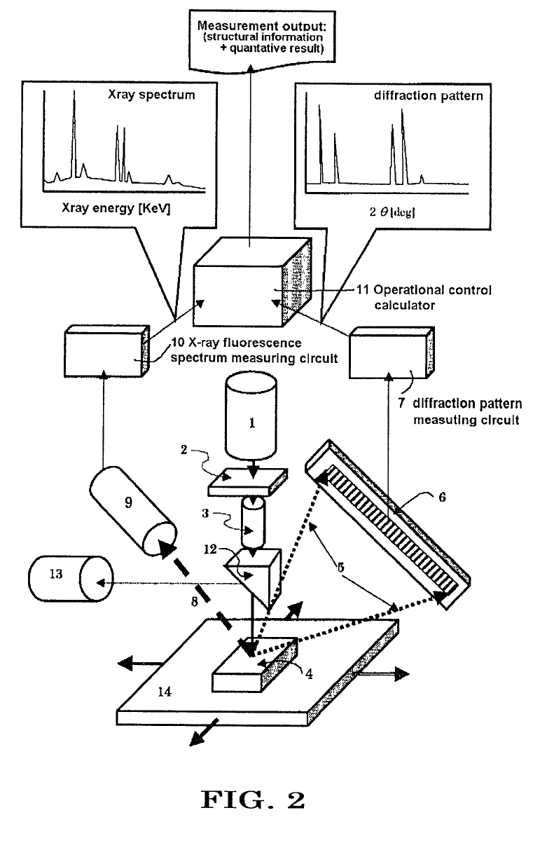

An embodiment enabling simultaneous measurement of X-ray fluorescence analysis and X-ray diffraction analysis is shown in FIG. 2. A sample 4 is mounted on a stage 14 and after an irradiation position is confirmed using a sample observation mirror 12, CCD 13 and an optical microscope, X-rays generated from an X-ray emitting source constituted by the X-ray tube 1 are irradiated by being focused using the collimator 3 and diffracted X-rays 5 generated from the sample 4 are incident to the CCD line sensor 6. First order X-rays generated from the X-ray tube 1 are made monochromatic at the primary filter 2 for X-ray diffraction analysis. Line information from the CCD line sensor 6 is processed at a diffraction pattern measuring circuit 7 and X-ray intensity is processed at an operational control calculator 11 as diffraction pattern information for the diffraction angle. Reference material patterns for each material are pre-stored and then compared with a pattern of an as yet unknown sample to identify a material. Fluorescent X-rays 8 generated simultaneously with diffraction pattern measurements are detected by an energy distributed X-ray detector 9 having a fixed angular position, an X-ray fluorescence spectrum is obtained by measuring using the diffraction pattern measuring circuit 7, a structural element is identified from the result of the structural analysis of the X-ray diffraction, and quantative calculations are performed at an operational control calculator 10 using the structural element data. The setting of a measuring position (positioning) is performed by moving the sample stage 14.

With the present invention, an X-ray analysis apparatus with an X-ray diffraction function can be realized where an X-ray generating system of low output can be used in common and where elemental analysis and structural analysis can be carried out in a single measurement. As a result, it is possible to have accurate quantative analysis, shorten the measuring time and reduce the installation space for the apparatus.

What is claimed is:

1. An X-ray analysis apparatus comprising:
a common X-ray emitting source;
a primary filter for making first order X-rays monochromatic;
a collimator for focusing first order X-rays;
an energy distributed X-ray detector taken as elementary analysis means for X-ray fluorescence analysis;
a sample observation optical system for confirming a measuring position of a microscopic portion;
a sample stage for positioning;
a CCD line sensor taken as structural analysis means for X-ray diffraction; and
a control calculator for analyzing respective results.
